(19) United States
(12) Patent Application Publication
(10) Pub. No.: US 2004/0034768 A1
(43) Pub. Date: Feb. 19, 2004

(54) Data encryption device based on protocol analyse

(76) Inventor: Juri H. Poldre, Tallinn (EE)

Correspondence Address: COATS & BENNETT, PLLC, P O BOX 5, RALEIGH, NC, 27602, US

(21) Appl. No.: 10/415,564

(22) PCT Filed: Oct. 30, 2001
(86) PCT No.: PCT/EE01/00008

(30) Foreign Application Priority Data
Nov. 2, 2000 (EE) P 200000390

(51) Int. Cl. H04L 9/00

(52) U.S. Cl. 713/153; 713/201

(57) ABSTRACT

Cryptograhic device (CND) that encrypts the user data passing through it. CND is located between HOST and DTE. It has two interfaces communicating through the INT protocol. CND analyzes the transmission and encrypts/decrypts user data on the fly. The device bypasses all control and status information required for the protocol and only encrypt the user data that are being transported by the INT protocol.

### FIELD OF INVENTION

The invention relates to encryption device for protection of data stored in the memory. Encryption device encrypts the user data passing the device, so that unauthorized user has no acess to data.

### BACKGROUND OF THE INVENTION

In prior art are known three encryption methods implemented in three different locations: Software on HOST, Hardware on HOST, and Hardware (firmware) on DTE.

EP 0936774 “Recording of scrambled digital data” discloses conception for using software solution and data encrypted storage. A system for transmission and recording of digital data comprises transmission means adapted to prepare and transmit scrambled digital data together with at least one encrypted control word, and a digital recording device adapted to receive and record the scrambled digital data and encrypted control word. Digital recording device further includes an access control means adapted to decrypt the control word and thereafter descramble the digital data during playback. Therefore the said solution permits the free transmission of digital data since the data in question will be transmitted and recorded in scrambled form on the digital support medium, and may only be accessed thereafter in conjunction with the recording device and associated access control module. The software solution while being the least expensive is also the least secure and demands CPU resources.

EP 080017 “Secondary storage data protection apparatus placing encryption circuit in I/O subsystem” discloses an I/O subsystem connected to the host computer. The devivce involves encryption/decryption hardware placed inside of the I/O subsystem which forms the interface between the host computer and the secondary storage devices. All data being transferred between the host computer and the storage devices is encrypted/decrypted by this hardware. The said solution provides sufficient security, however it is integrated on the host level, which requires solving of the integration problems for every specific case. This solution also requires different driver for every hardware/software platform. In many cases it is necessary to replace the whole host, because DTE intreface is often the integral part of the host.

EP 0911738 “Disk drive with embedded data encryption” is described an encryption/decryption circuit, connected to read/write means of the drive. The said solution however is also not widely implemented. Adding encrytpion/decryption device to the DTE increases its cost and power consumption. Adding cryptography to DTE increases its cost and power consumpiton. This may not be a desirable solution in all cases and users would not tolerate added costs for unused hardware. The said encryption/decryption device is integrated within DTE and the device is not transparent for the protocol applied between host and DTE. The said patent does not provide possibility to increase the security of the existing storage device, but instead provides the solution by adding a new DTE.

The present invention is related to the device, that comprises HOST and DTE (Data Terminal equipment). Host accesses the DTE through interface INT. The INT is usually standardized interface and can handle several DTEs connected to it. For example PC with IDE interface can handle two hard disks. In this case PC with IDE interface is HOST and hard disk is the DTE. In another example several smaller memory units can be connected to PC USB bus. In that case the PC USB forms the HOST and the memory units are the DTEs. The data can be in remote location and accessed via network. Here INT is the Ethernet interface connected to host. It must be said that the invention is by no means connected to PC architecture and applies to all data transmissions following the HOST-INT-DTE architecture.

As the complexities of integrated circuits increase the cost of gates decrease. It becomes feasible to add additional gates to the system to increase its functionality with less cost. The cryptography devices also require a high level of confidence to be trustworthy. This means that all algorithms must be secure and there should be a possibility to verify that the unit calculates the transform that it is supposed to. This eliminates the possibility of built-in backdoor.

For providing a wide range of utility applications the device is designed to be integrateable into the existing medium. The present invention describes the device, enabling to increase the security of the existing pair of HOST-DTE without replacing any of the components.

### SUMMARY OF THE INVENTION

The object of the invention is to protect user data against unauthorized access. Cryptographic device (CND) is located between HOST and DTE. The device has two interfaces what communicate using the INT protocol. CND analyzes the transmission and encrypts/decrypts user data on the fly. The device bypasses all control and status information required for the protocol and only encrypts the user data, that is transported using INT protocol.

For example let us look at the IDE protocol. The controller sends commands to HDD setting the values in the HDD. The data transmission is initialized by sending the control info and then reading/writing the data in one of the previously agreed methods (DMA, UDMA, PIO). The CND intercepts the communication and stores the values for this data transmission. When HOST is ready to receive data it reads the data from HDD, decrypts it and sends it to HOST.

The device can be configured from HOST using the INT protocol. The device will intercept the configuration commands unic to the device and not pass them to HOST.

The device can also be configured from dedicated external bus using separate interface. This may be connected to any kind of information input/transmisson device e.g. keyboard, infrared link, bluetooth radio module etc.

Although the device is mostly in transparent mode it listens to the communication on the bus and can perform certain housekeeping actions based on it's internal state and commands from bus. For example when the HOST tells the DTE to go to the low-power mode CND may respond to that by also going to low-power mode.

Because the device is situated between the HOST and DTE it can easily be integrated into both of them. If the interface inside the integrated part is removed then the designers must check the compliance with the existing standards. Apart from the legal limitations the actual integrating process is very easy.

### BRIEF DESCRIPTION OF THE DRAWINGS

Preferred embodiments of the invention will now be illustrated by way of example only and with reference to the accompanying drawings in which:

FIG. 1 is a block diagram of the encrypting device according to the invention;

FIG. 2 is block diagram for protecting the user data according to the invention.

### DETAILED DESCRIPTION OF THE INVENTION

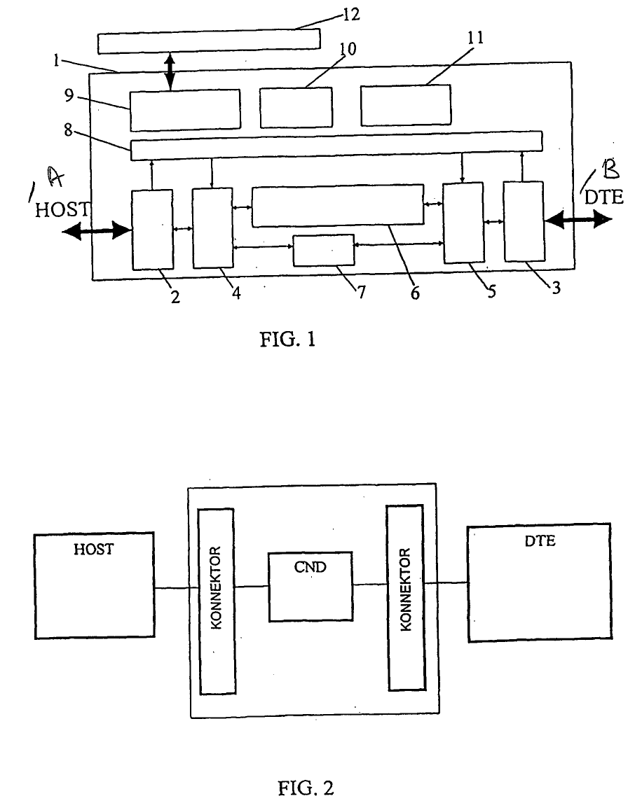

FIG. 1 a shows a block diagram of the encrypting device. Encrypting device 1 comprises interfaces 2 and 3, multiplexers 4 and 5, crypto pipeline 6, bypass circuit 7, protocol analyzer 8, control unit 9, memory 10, random number generator 11.

Interfaces 2 and 3 are required to connect the device between DTE and HOST. The usual connection of this device requires both the HOST and DTE side INT to be the same. Under situations where this is not a requirement the CND must perform also the protocol translation. The INT may conform to several physical standards on the OSI data link layer e.g. IDE requires UDMA, PIO and MWDMA.

Multiplexers 4 and 5 select between bypass 7 and crypto pipeline 6 between two interfaces. This is used to bypass all other information except user data to be encrypted.

Crypto pipeline 6 includes a block cipher in one of the feedback modes. For each transaction initial vector and key is provided from control unit 9. The pipeline 6 can be in either encrypt or decrypt mode. The specific algorithm used is not determined in the scope of this patent.

Bypass 7 is required to bypass the data in case encryption is not required. This is necessary e.g. for all status and control info for DTE.

The protocol analyzer 8 listens to both interfaces and extracts the control and status information required to put the CND in one of the operational modes. The required modes are:

1) bypass the data

2) encrypt the data

3) decrypt the data

The list of modes is not limited to the above three.

The control unit 9 updates the state of CND based on the infromation from the protocol analyzer 8. It may also communicate with external interface if implemeted.

The memory 10 is used to store the commands and state of the CND. This includes but is not limited to keys and algorithm for control unit.

The position 11 is a random number generator. This is optional block. If implemented it can be used to create seeds for key exchange and session keys. The random number generator 11 must be cryptographically secure what implies certain tests and physical randomness source.

The optional control interface 12 can be used to input key material or control parameters and read back the status. There should be no way to read the actual data through this interface to protect from evesdropping. This interface may be connected e.g. to external keypad, wireless data transfer module (Bluetooth), Infrared link or smart card.

The actual product to fulfill the requirements above is based on but not limited to specially designed integrated circuit, what incorporates all necessary functionality for encrypting and decrypting data in real-time as well as handling the data storage media interfacing and signalling. CND (integrated circuit) can be mounted on small circuit board together with all connectors required for connecting the device between the HOST and DTE.

The setup and control can be implemented by using the HOST interface or external control bus. In case interface is used the CND will intercept the commands coming from HOST. It will not pass these on to the device but will change internal state appropriately.

The actual key exchange algorithm is not defined in the this patent. If implemented the key exchange will be implemeted in memory and carried out by control unit. The RNG can be used to seed the key generation processes. The possible algorithms can be e.g. RSA, Diffie-Hellman. The exact data encryption algorithm is out of the scope of the present invention and can be whatever that provides the data protection e.g. 3DES, IDEA, CRAB, BLOWFISH, AES. The encryption key can be entered manually in the form of password or pass-phrase by user; or provided using special hardware key units, connecting such unit with the encryption device using external control bus. The key may also be generated using the physical random number generator on device. This generator is not required when session key is input to device directly.

1. Data encryption device for protecting user data against unauthorized access, device is located between HOST and DTE, comprising:
interfaces (2) and (3) for connecting the device between DTE and HOST;
multiplexers (4) and (5) for channeling of information;
crypto pipeline (6) for data encryption/decryption;
bypass circuit (7) for passing nonencrypted/nondecrypted data;
protocol analyzer (8) for communicating with the interfaces (2) and (3);
control unit (9) for updating of the device;
memory (10) for storage of the commands and state of the device;
random number generator (11) for generating key exchange and session keys;
optional control interface (12) for using regarding input key material and control parameters and read back the status.

2. Device according to claim 1, wherein crypto pipeline (6) comprises block cipher in one of the feedback modes.

3. Device according to claim 1, wherein protocol analyzer (8) is arranged to switch the device into one of the following modes: a) bypass of data; b) encryption of data; and c) decryption of data.

4. Device according to claim 1, wherein protocol analyzer (8) is arranged to switch the device into a certain mode based on the command received from the bus.

5. Device according to claim 1, wherein the control unit (9) is arranged to provide the initial vector and key for each session.

6. Device according to claim 1, wherein the optional control interface (12) is connected to external keypad, wireless data transfer module (Bluetooth), Infrared link or smart card.

7. Device according to claim 1, wherein the device is arranged to be transparent to protocol.

8. Device according to claim 1, wherein the device is arranged to be able to translate the protocol on need.

9. Device according to claim 1, wherein the device is arranged to analyze the transmission and encrypt/decrypt the user data during traffic.

10. Device according to claim 1, wherein the device can be connected to any input/transmission device like keyboard, infrared link, Bluetooth radio module, etc.

11. Device according to claim 1, wherein the device is integrated into existing medium.

12. Device according to claim 1, wherein the device is a separate unit.
